(19) United States
(12) Patent Application Publication
(10) Pub. No.: US 2025/0207673 A1
(43) Pub. Date: Jun. 26, 2025

(54) DIRECTIONAL VALVE

(71) Applicant: Festo SE & Co. KG, Esslingen (DE)

(72) Inventors: Eduard USINGER, Aichwald (DE); Eduard WENSKE, Kornwestheim (DE)

(21) Appl. No.: 18/984,479

(22) Filed: Dec. 17, 2024

(30) Foreign Application Priority Data
Dec. 21, 2023 (DE) 102023136193.7

(51) Int. Cl. F16K 11/07; F16K 15/04

(52) U.S. Cl. CPC F16K 11/0716; F16K 15/04

(57) ABSTRACT

A directional valve including a valve housing, in which a slide receiving space is formed extending in a longitudinal direction and limited radially outwards by a peripheral receiving space boundary surface, in which a plurality of valve channels open, which pass through the valve housing and are spaced in the longitudinal direction at points in the peripheral receiving space boundary surface, and in which a valve slide, having at least one slide body, is arranged, which is displaceable in the longitudinal direction between a plurality of switch positions by executing a switching movement, and with at least one check valve member, which is movable relative to the slide body depending on the applied pressure difference, a receiving chamber is formed in the slide body. The check valve member is arranged axially movable and which is connected to the feed channel via a connecting channel formed in the slide body.

### CROSS-REFERENCE TO RELATED APPLICATION

This application claims the benefit of German application DE 10 2023 136 193.7 filed Dec. 21, 2023, which is incorporated herein by reference.

The invention relates to a directional valve, with a valve housing, in which a slide receiving space is formed extending in a longitudinal direction along a longitudinal axis and limited radially outwards by a peripheral receiving space boundary surface, in which a plurality of valve channels open, which pass through the valve housing and are spaced in the longitudinal direction at points in the peripheral receiving space boundary surface, and in which a valve slide, having at least one slide body, is arranged, which is displaceable in the longitudinal direction between a plurality of switch positions by executing a switching movement, wherein the valve channels contain at least one feed channel that can be connected to a fluidic pressure source and at least one working channel that can be connected to an actuated fluid consumer, wherein the feed channel opens into a feed longitudinal section and the working channel opens into a working longitudinal section of the slide receiving space axially adjoining the feed longitudinal section, wherein the valve slide in a first switch position fluid-tightly separates the feed longitudinal section from the working longitudinal section, and in a second switch position releases a fluid connection between the feed longitudinal section and the adjacent working longitudinal section, and with at least one check valve, having a check valve member, which is movable relative to the slide body depending on the applied pressure difference.

For the safety of a system equipped with a directional valve, in particular a directional valve, which also includes a fluid consumer, it is sometimes necessary to completely vent the system. In this case, the feed channel is separated from the pressure source and connected to the atmosphere like the ventilation ducts. This is achieved by means of an upstream ventilation valve.

So that a connected fluid consumer is also completely vented during the venting of a system, DE 10 2014 112 110 A1 provides for a residual pressure relief valve attached to a multidirectional valve. The residual pressure relief valve is connected to the two working channels and is controlled by the fluid pressure prevailing in the feed channel. When the feed channel is vented, the residual pressure relief valve switches to a ventilation position, in which it connects the two working channels to the atmosphere independently of the valve channels of the multidirectional valve and causes a consumption of ventilation fluid. The constructive effort associated with these residual pressure ventilation measures is however considerable and increases the dimensions of the valve arrangement, since the residual pressure relief valve is attached to the main valve.

A directional valve of the above mentioned type is known from the DE 10 2020 133 997 A1. The residual pressure ventilation measures are achieved here via at least one aeration seal ring, which is designed as a movable check valve member relative to the slide body of a valve slide depending on the applied axial pressure difference.

### SUMMARY OF THE INVENTION

The object of the invention is to provide a directional valve with which a reliable residual pressure relief is possible with minimal constructive effort and possibility of compact dimensions.

This problem is solved by the features of the disclosure. Further formations of the invention are shown in the subclaims.

The distinguishing feature of the inventive directional valve is that a receiving chamber is formed in the slide body, in which the check valve member is arranged in an axially movable manner and which is connected to the feed longitudinal section via a connecting channel formed in the slide body, wherein a valve seat is located opposite the check valve member, which borders an overflow opening, which is connected to the working longitudinal section of the slide receiving space via a relief channel.

By integrating the check valve into the slide body of the valve slide, a particularly compact and inexpensive solution for residual pressure relief is achieved. Furthermore, such a check valve is mechanically simple in structure and consists of only relatively few components.

In a further formation of the invention the valve channels contain at least one ventilation duct connectable to a pressure sink, which opens into a ventilation longitudinal section of the slide receiving space, wherein the valve slide in the first switch position fluid-tightly separates the working longitudinal section and the ventilation longitudinal section, in the second switching fluid-tightly separates the working longitudinal section from the ventilation longitudinal section, and in a third switch position releases a fluid connection between the working longitudinal section and the ventilation longitudinal section, while simultaneously the feed longitudinal section is fluid-tightly separated from the working longitudinal section. The directional valve is usefully formed here as a multidirectional valve, for example with 3/3 functionality.

In a further formation of the invention the further working longitudinal section of the slide receiving space, which is connected to a further working channel, is adjoined to the side of the feed longitudinal section which axially opposes the working longitudinal section, to which a further ventilation longitudinal section of the slide receiving space, which is connected to a further ventilation duct, is axially adjoined, wherein the valve slide in the first switch position fluid-tightly separates the feed longitudinal section and the further working longitudinal section, while the further working longitudinal section is simultaneously fluid-tightly separated from the further ventilation longitudinal section, in the second switch position the feed longitudinal section is fluid-tightly separated from the further working longitudinal section, while a fluid connection is simultaneously released between the further working longitudinal section and the further ventilation longitudinal section, and in the third switch position a fluid passage is released between the feed longitudinal section and the further working longitudinal section, and the further working longitudinal section is simultaneously fluid-tightly separated from the further ventilation longitudinal section.

This design can be particularly advantageous in multidirectional valves that have a 2/2 valve function or a 3/3 valve function or a 5/3 valve function.

In a particularly preferred way, a further check valve allocated to the further working channel, having a further check valve member, is provided, which is movable relative to the slide body depending on the applied pressure difference. In a multidirectional valve with 5/3 valve function, this permits ventilation or residual pressure relief for example of the two working chambers of a fluid consumer, for example a double-acting fluid cylinder, in the first switch position of the directional valve, in which both the aeration and ventilation function is blocked.

In a particularly preferred way the further check valve member of the further check valve is accommodated likewise axially movable in the receiving chamber of the slide body, which is connected to the feed longitudinal section via a further connecting channel formed in the slide body, wherein a further valve seat is located opposite the further check valve member, which borders a further overflow opening, which is connected to a further working longitudinal section of the slide receiving space via a further relief channel.

In a particularly preferred way the connecting channel has a passageway channel section aligned coaxially to the longitudinal axis of the slide receiving space, which ends at the valve seat of the check valve, and wherein the connecting channel has an end channel section extending in the radial direction to the longitudinal axis, which is connected on the one hand to the passageway channel section and on the other hand to the feed longitudinal section. Usefully the further connecting channel also has a further passageway channel section aligned coaxially to the longitudinal axis of the slide receiving space, which ends at the further valve seat of the further check valve, and wherein the further connecting channel has a further end channel section extending in the radial direction to the longitudinal axis, which is connected on the one hand to the further passageway channel section and on the other hand to the feed longitudinal section.

In a particularly preferred way, the passageway channel section and the further passageway channel section are fluidically connected to each other and the end channel section and the further end channel section are one and the same channel.

However, other embodiments of the passageway channel sections and end channel sections are also conceivable, for example in that the two end channel sections are formed as separate channels.

In a further formation of the invention the relief channel has an overflow channel section aligned coaxially to the longitudinal axis of the slide receiving space, whose opening, which is aligned to the check valve member, forms the overflow opening, which can be closed by the check valve member, and wherein the relief channel has an inflow channel section extending in a radial direction to the longitudinal axis, which is connected on the one hand to the working longitudinal section and on the other hand to the overflow channel section.

Usefully the further relief channel also has a further overflow channel section aligned coaxially to the longitudinal axis of the slide receiving space, whose opening, which is aligned to the further check valve member, forms the overflow opening, which can be closed by the check valve member, and wherein the relief channel has a further inflow channel section extending in a radial direction to the longitudinal axis, which is connected on the one hand to the further working longitudinal section and on the other hand to the further overflow channel section.

In a particularly preferred way, the check valve members are formed spherically or conically. The design of the check valve members as balls with associated ball seat enables fault exclusion of not switching back to the base position according to ISO 13849-2. This permits the use of the directional valve for the STO safety function (Safe Torque Off) up to category 3 Pld.

In a further formation of the invention the valve seat, in particular the two valve seats, is formed on a valve seat body, which in turn is accommodated in the receiving chamber of the slide body and fixed there in an axially immovable manner.

In a further formation of the invention the check valve member is axially movable between a closed position, tightly fitting the valve seat and fluid-tightly closing the overflow opening, and an open position, raised from the valve seat, wherein the open position is predetermined by a stop element protruding into the receiving chamber.

Usefully the further check valve member is also axially movable between a closed position, tightly fitting the further valve seat and fluid-tightly closing the further overflow opening, and an open position, raised from the further valve seat, wherein the open position is predetermined by a stop element protruding into the receiving chamber.

In a particularly preferred way the same stop element, which serves to specify the opening positions of the check valve members, has a first stop surface for the check valve member and a second stop surface, arranged opposite the first stop surface, for the further check valve member.

In a further formation of the invention the directional valve contains a spring device, by which the valve slide is held flexibly in the first switch position under preload. When the valve slide is deflected by application of an actuating force from the first switch position to either the second switch position or the opposing third switch position, a unilateral compression of the spring device takes place, which, when the actuating force is removed, can cause the valve slide to return to the first switch position.

For generating the actuating force which causes the switching movement, the directional valve is suitably equipped with an electrofluidic and in particular an electropneumatic pilot valve device. Basically, the multidirectional valve can be designed, for example, also for direct electromagnetic or pneumatic actuation.

The directional valve is particularly suitable for controlling a gaseous pressure medium, in particular compressed air, but it can also be used to control liquid pressure media. The term ventilation used in various places is to be understood, irrespective of the type of fluidic pressure medium used, as a synonym for pressure relief on, in particular, atmospheric pressure.

The invention further comprises a valve slide having the features of the disclosure.

The distinguishing feature of the inventive valve slide is that a receiving chamber is formed in the slide body, in which at least one check valve is accommodated, having a check valve member arranged in an axially movable manner in the receiving chamber.

Finally, the invention comprises a method for retro-fitting a directional valve, with a valve housing, in which a slide receiving space is formed extending in a longitudinal direction along a longitudinal axis and limited radially outwards by a peripheral receiving space boundary surface, in which a plurality of valve channels open, which pass through the valve housing and are spaced in the longitudinal direction at points in the peripheral receiving space boundary surface, and in which a valve slide, having at least one slide body, is arranged, which is displaceable in the longitudinal direction between a plurality of switch positions by executing a switching movement, wherein the method comprises the following steps:
Removal of the valve slide from the directional valve and
replacement of the removed valve slide by installing a valve slide, in which a receiving chamber is formed, in which at least one check valve is accommodated, having a check valve member arranged in an axially movable manner in the receiving chamber.

### BRIEF DESCRIPTION OF DRAWINGS

A preferred exemplary embodiment of the inventive directional valve is shown in the drawings and is explained in more detail below. Drawings:

FIG. 1 shows a perspective illustration of a preferred exemplary embodiment of the inventive directional valve,

FIG. 2 shows a longitudinal section through the directional valve of FIG. 1, wherein the valve slide is in the second switch position,

FIG. 3 shows a longitudinal section through the directional valve of FIG. 1, wherein the valve slide is in the first switch position and residual pressure relief is not active,

FIG. 4 shows a longitudinal section through the directional valve of FIG. 1, wherein the valve slide is in the first switch position and residual pressure relief of the working channel takes place via the working longitudinal section and the feed channel with the feed longitudinal section,

FIG. 5 shows a longitudinal section through the directional valve of Figure, wherein the valve slide is in the first switch position and residual pressure relief of the further working channel takes place via the working longitudinal section and the feed channel with the further feed longitudinal section and

FIG. 6 shows an enlarged representation of the number X from FIG. 3.

### DETAILED DESCRIPTION OF INVENTION

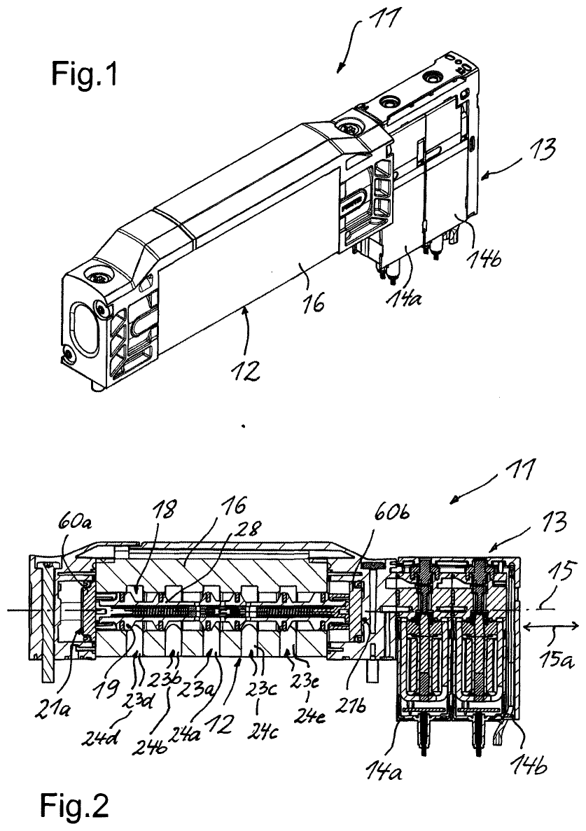

FIGS. 1 to 6 show a preferred exemplary embodiment of the inventive directional valve 11. The directional valve 11 is shown and described by means of a multidirectional valve. In principle, the invention would also be conceivable on a “one-way valve”, for example in the form of a 2/2 valve, in which, depending on the switch position of the valve, “a path” is either open or closed.

The directional valve 11 is usefully of an electrofluidically and in particular electropneumatically piloted design. This is true of the illustrated embodiment. In this respect, the directional valve 11 has a main valve 12, which is equipped with an electrically actuable pilot valve device 13. The pilot valve device 13 has at least one and, for example, two electrically actuable pilot valves 14a, 14b, which are usefully solenoid valves. The structure of the pilot valves is not discussed in detail below.

The directional valve extends along a longitudinal axis 15, whose axial direction is referred to below as longitudinal direction 15a.

The directional valve 11 has a valve housing 16, which by way of example is a component of the main valve 12. The pilot valve device 13 is mounted in the example shown on one of the two end faces 17 (FIG. 3) of the valve housing 16, oriented in the longitudinal direction 15a.

In the valve housing 16 an elongated cavity, extending in the longitudinal direction 15a, is formed, which forms a slide receiving space 18 for receiving a valve slide 19. In the illustrated piloted valve design, the slide receiving space 18 and the valve slide 19 belong to the main valve 12. The valve slide 19 has an elongate shape and extends in the slide receiving space 18 in the longitudinal direction 15a.

The valve slide 19 can be moved back and forth in the slide receiving space 18 relative to the valve housing 16 by executing a linear switching movement 20 in the longitudinal direction 15a indicated by a double arrow. In this way, it can be positioned in different axial switch positions relative to the valve housing 16. The actuating force for generating the switching movement 20 and preferably also for holding the valve slide in the set switch position is, for example, a fluid force, which can be generated by a pilot fluid, to which the valve slide 19, which is controlled by means of the pilot valve device 13, can be axially exposed. For example, two first and second actuator areas 21a, 21b are allocated in the valve slide 19, facing in opposite alignment of the longitudinal direction 15a to each other, each of which can be exposed to or relieved of pressure via a pilot channel communicating with the pilot valve device 13 (not shown) alternatively the pilot control fluid.

For example, one of two drive pistons 60a, 60b is allocated to each axial end area of the valve slide 19, on each of which one of the two actuator areas 21a, 21b is formed and which can be axially supported for transferring a driving force to the valve slide 19.

Compressed air is used in particular as pilot fluid, wherein alternatively another pressure fluid can also be used.

The slide receiving space 18 is limited radially outwards by a radially inward-facing peripheral receiving space bordering surface 22. Viewed in a cross section perpendicular to the longitudinal axis 15, the receiving space boundary surface 22 has a round and preferably circular contour.

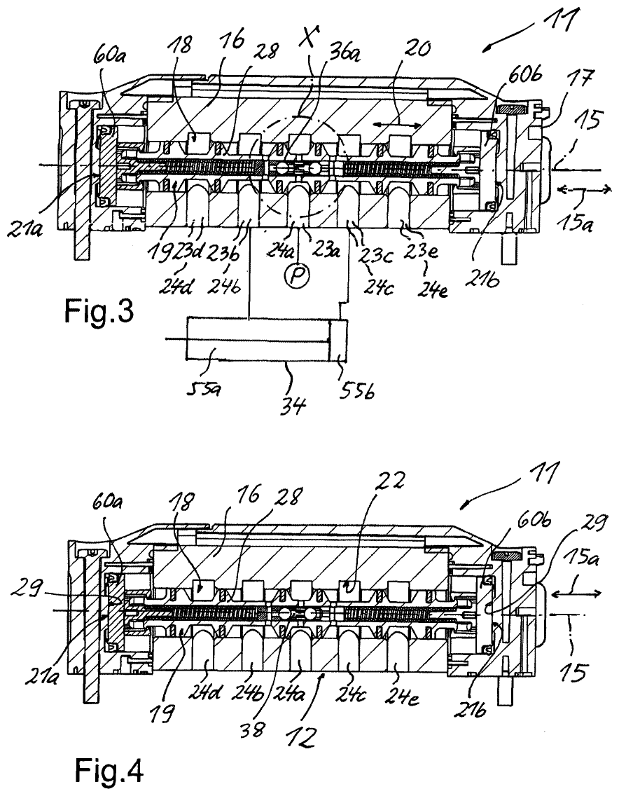

The slide receiving space 18 has a plurality of slide receiving space longitudinal sections 23 arranged in the longitudinal direction 15a sequentially, into which each one of a plurality of valve channels 24, which pass through the valve housing 16, open at the receiving space boundary surface 22 (FIG. 4). The opening areas of the plurality of valve channels 24 are spaced apart from each other in the longitudinal direction 15a.

Preferably the directional valve 11 is a 5/3 directional valve with a total of five valve channels 24, which can be connected to each other and/or separated from each other by the valve slide 19 in different control configurations. Such a design is present in the illustrated embodiment. Here, the directional valve 11 is preferably formed as a 5/3 way directional valve whose valve slide 19 can be positioned in three alternative switch positions for specifying different control configurations.

In the drawing in FIG. 3, the valve slide 19 is shown occupying a first switch position. This is preferably a middle position, from which the valve slide 19 can be switched into a second switch position by a right-facing switching movement 20 or into a third switch position by a left-facing switching movement 20. The second switch position is shown in FIG. 2. The third switch position is not illustrated in the figures.

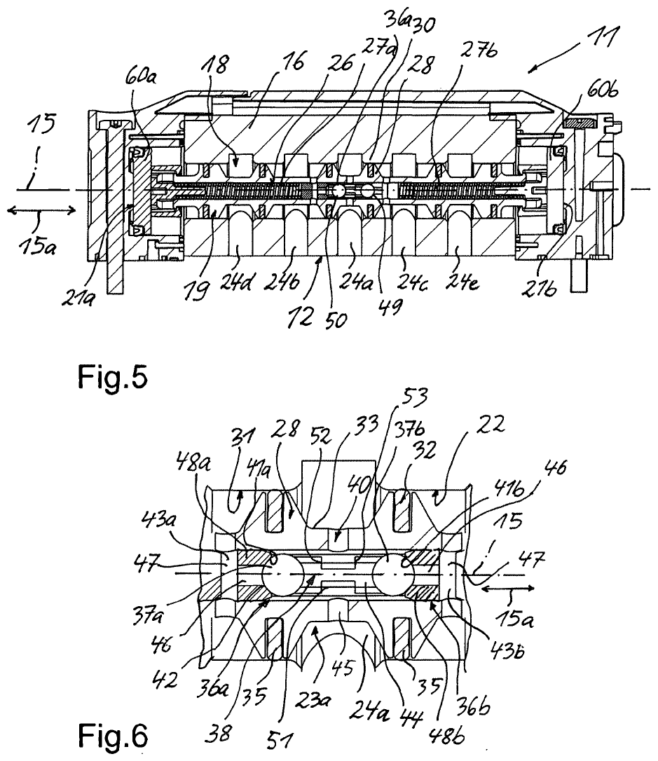

Preferably the valve slide 19 is retained in the first switch position by spring tension so that the first switch position is a base position occupied by the valve slide 19 in the absence of an actuating force. By application of an actuating force, the valve slide 19 is movable in either one or the other axial direction and can be positioned in either the second switch position or the third switch position, from which it is moved back again to the first switch position by the spring force, as soon as the current actuating force is once again removed. The spring tension is provided by a spring device 26 of the directional valve 11, which is supported between the valve slide 19 and the valve housing 16. By way of example, the spring device 26 (FIG. 5) consists of two compression springs 27a, 27b (FIG. 5), which are each axially interposed between a sliding body 28 extending in the slide body receiving space 18 of the valve slide 19 and one of the two drive pistons 60a, 60b. In this case, the drive pistons 60a, 60b are axially movable relative to the slide body 28 and tensioned by the compression springs 27a, 27b with end surfaces 29 (FIG. 4) of the valve housing 16, which limit the slide receiving space 18 axially on both sides.

In the following the slide receiving space longitudinal sections 23 are also named individually. Accordingly, the slide receiving space longitudinal sections 23 contain a feed longitudinal section 23a, which is axially flanked on one side by a working longitudinal section 23b and on the other side by a further working longitudinal section 23c. For differentiation purposes, the working longitudinal section 23b is also referred to below as first working longitudinal section 23b and the further working longitudinal section 23c is also referred to as second working longitudinal section 23c.

A ventilation longitudinal section 23d, for differentiation purposes also referred to below as first ventilation longitudinal section 23d, follows the first working longitudinal section 23b axially, while a further ventilation longitudinal section 23e, for differentiation purposes also referred to as second ventilation longitudinal section 23e, follows the second working longitudinal section 23c.

The valve channels 24 are, by way of example, a feed channel 24a opening into the feed longitudinal section 23a, a working channel 24b opening into the first working longitudinal section 23b, also referred to below as first working channel 24b, a further working channel 24c opening into the second working longitudinal section 23c, also referred to below as second working channel 24c, a ventilation duct 24d opening into the first ventilation longitudinal section 23d, also referred to below as first ventilation duct 24d, and a further ventilation duct 24e, also referred to below as second ventilation duct 24e, which opens into the second ventilation longitudinal section 23e.

Between slide receiving space longitudinal sections 23, directly adjacent in the longitudinal direction 15a, extends in each case a transition section 30 (FIG. 5), in the area of which the receiving space bordering surface 22 forms a cylindrical sealing surface 31 (FIG. 6), which for differentiation purposes is also referred to below as transition sealing surface 31. The diameter of the slide receiving space 18 is smaller in the area of the transition longitudinal sections 30 than in the area of the slide receiving space longitudinal sections 23, in each of which one of the valve channels 24 opens.

In the area of its radial outer circumference, the slide body 28 supports a seal structure 32 belonging to the valve slide 19, which moves uniformly with the slide body 28 during the switching movement. The purpose of the seal structure 32 is to define the individual control configurations of the valve channels 24 by selectively sealing the interaction with the transition sealing surfaces 31. When the sealing structure 32 fits tightly against a transition sealing surface 31, it fluid-tightly separates the two slide receiving space longitudinal sections 23 allocated axially adjacent to it. Accordingly, the valve channels 24, which communicate with the relevant slide receiving space longitudinal sections 23, are then also separated from each other. If the valve slide 19 is positioned so that the sealing structure 32 does not fit tightly against one of the transition sealing surfaces 31, because it is moved out of the area of the slide receiving space 18 enclosed by the transition sealing surface 31, an open fluid connection then exists between the slide receiving space longitudinal sections 23 axially adjacent on both sides of the transition sealing surface 31, so that the connected valve channels 24 are also fluid-tightly connected to each other.

Between axially adjacent sections of the sealing structure 32, the valve slide 19 as in each case a constricted longitudinal section 33 (FIG. 6), which is reduced in diameter and, with an open fluid connection, promotes the fluid flow.

The feed channel 24a can be connected to a fluid pressure source P, wherein in normal operation of the directional valve 11 it is connected to this fluidic pressure source P. The fluidic pressure source P provides a fluidic pressure medium, for example compressed air. Each working channel 24b, 24c can be connected to a fluid-actuated fluid consumer 34 and in normal operation of the directional valve 11 is connected to such a fluid consumer 34. The fluid consumer 34 is in particular a fluid-actuated drive, for example a pneumatic cylinder. Each ventilation duct 24d, 24e is connected to a pressure sink R, in particular the atmosphere.

For the fluid connection to the fluidic pressure source P and the fluid consumer 34, fluid lines connected to the valve housing 16 at the relevant valve channels are usefully used. For connection to the atmosphere, the ventilation ducts 24d, 24e can open directly externally at the valve housing 16.

The sealing structure 32 usefully contains a plurality of seal rings 35, coaxially arranged on the slide body 28 and fixed to the slide body 28 at an axial distance from each other. One of the above-mentioned longitudinal sections 33 is located between each of the adjacent sealing rings 35. Each of the sealing rings 35 is allocated to one of the transition sealing surfaces 31, which it has radial sealing contact with when it occupies a position enclosed by the allocated transition sealing surface 31 in the transition longitudinal section 30. In this case the slide receiving space longitudinal sections 23 arranged axially adjacent to the transition longitudinal section 30 are fluid-tightly separated from each other. In addition, the valve slide 19 may occupy positions in which at least one sealing ring 35 has left the allocated transition longitudinal section 30, so that an annular intermediate space exists between the allocated transition sealing surface 31 and a constricted longitudinal section 33 of the valve slide 19 through which the fluidic pressure medium can flow.

Each transition sealing surface 31 extend between two of the slide receiving longitudinal sections 23, in the area of which the diameter of the slide receiving space 18 is greater than in the transition longitudinal section 30 enclosed by the transition sealing surface 31, so that a seal ring 35 does not deploy any sealing effect, when it is positioned in the area of one of the slide receiving space longitudinal sections 23.

As already mentioned, the valve slide is in the first switch position in a base position, which, as mentioned, is also referred to as a middle position. If no pilot pressure is applied, the valve slide is switched to the first valve position or base position by the force of the compression springs 27a, 27b.

As shown in FIG. 3 in particular, the feed channel 24a in the first valve position is fluid-tightly separated from the first and second working channel 24b, 24c, which are located left and right of the feed channel 24a in the axial direction. In other words, the feed longitudinal section 23a is fluidly separated from the first and from the second working channel longitudinal section 23a, 23b via the two sealing rings 35. In this first valve position the two ventilation ducts 24d, 24e are also fluidly separated from the working channels 25d, 25c, because here the allocated sealing rings 35 likewise fit fluid-tight on the relevant transition sealing surfaces 31. In other words, the working longitudinal sections 23b, 23c are fluid-tightly separated from the ventilation longitudinal sections 23d, 23e.

For the safety of a system equipped with a directional valve 11, which also includes the fluid consumer 34, it is sometimes necessary to completely vent the system, in other words implement residual pressure relief.

Here the directional valve 11 has at least one check valve 36, which has a check valve member 37, which is movable relative to the slide body 28 depending on the applied pressure difference. An essential aspect is that a receiving chamber 38 is formed in the slide body 28, in which the check valve member 37 is arranged in an axially movable manner and which is connected to the feed longitudinal section 23a via a connecting channel 40 (FIG. 6) formed in the slide body 28, wherein a valve seat 41 is located opposite the check valve member 37, which borders an overflow opening 42, which is connected to the working longitudinal section 23b of the slide receiving space 18 via a relief channel 43.

In the case of the preferred exemplary embodiment of the 5/3 directional valve described here, in addition to the check valve 36a, which for the sake of simplicity is referred to below as first check valve 36a, a further check valve 36b is provided, which is referred to below as second check valve. Consequently, the first check valve 36a has a first check valve member 37a and the second check valve 36b has a second check valve member 37b. In the example shown the check valves 36a, 36b are structured identically to each other. A ball, for example, is used as check valve member 37a, 37b. Consequently, the valve seat 41a, 41b of the first and second check valve 36a, 36b is designed as a ball seat. As shown in FIGS. 3 and 6 in particular, a connecting channel 40 is allocated to each of the two check valves 36a, 36b. The connecting channels are each connected to the feed channel 24a, which opens into the feed longitudinal section 23a, and end at the allocated overflow opening 42a, 42b of the allocated valve seat 41a, 41b. The connecting channels 40a, 40b each consist of two channel sections. A passageway channel section 44 is provided, which is aligned coaxially to the longitudinal axis 15 of the slide receiving space 18 and which ends at the valve seat 41a, 41b of the check valve 36a, 36b. Furthermore, the connecting channels 40a, 40b each have an end channel section 45, extending in a radial direction to the longitudinal axis 15 and connected on the one hand to the passageway channel section 44 and on the other hand to the feed longitudinal section 23a. As shown in FIG. 6, for example, the two passageway channel sections 40 are fluidically connected to each other and formed by a channel mutually formed in the slide body. The two end channel sections 45 are one and the same channel.

The relief channels 43a, 43b also each have two channel sections. An overflow channel section 46 is provided, which is aligned coaxially to the longitudinal axis 15, whose opening, which is aligned to the allocated check valve member 37a, 37b, forms the overflow opening 42, which can be closed by the check valve member 37a, 37b. Furthermore, the relief channels 43a, 43b have an inflow channel section 47, extending in a radial direction to the longitudinal axis 15 and connected on the one hand to the allocated working longitudinal section 23b, 23c and on the other hand to the allocated overflow channel section 46.

As shown in FIG. 6 in particular, the two valve seats 41a, 41b are each formed on an allocated valve seat body 48a, 48b, which on the one hand is accommodated in the receiving chamber 38 of the slide body 28 and fixed there, for example pressed, in an axially unmovable manner.

The check valve members 37a, 37b are axially movable between a closed position 49, tightly fitting the allocated valve seat 41a, 41b and fluid-tightly closing the overflow opening 42, and an open position 50 (FIG. 5), raised from the valve seat 41a, 41b, wherein the open position 50 is predetermined by a stop element 51 protruding into the receiving chamber 38. Usefully the same stop element 51, which serves to specify the opening positions 50 of the check valves 36a, 36b, has a first stop surface 52 for the check valve member 37a and a second stop surface 53, arranged opposite the first stop surface 52, for the second check valve member 37b.

It should also be noted that in the respective open position of the check valve member 37a, 37b, which is usefully designed as a ball, a flow of fluid is enabled between the outer surface of the ball and the inner wall of the receiving chamber 38, for example by a corresponding contouring, for example in the form of overflow channels (not shown).

With usual use of the directional valve 11, there is a constant incoming feed pressure provided by the pressure source P at the feed channel 24a, which represents the highest level of pressure within the fluid system equipped with the directional valve 11. In this state, the incoming feed pressure also acts on the check valve members 37a, 37b of the check valves 36a, 36b via the connecting channel 40, which are pressed by the incoming feed pressure into their respective closing position 49. The directional valve 11 can then be switched as needed from the first switch position to the second or third switch position, whereby the first or the second working channel is ventilated. At the same time, venting takes place in the other non-ventilated working channel via the allocated ventilation duct. This makes it possible, for example, to control a fluid consumer in the form of a double-acting pneumatic cylinder. Either one or the other working chamber 55a, 55b of the pneumatic cylinder is aerated or vented, so that the piston of the pneumatic cylinder retracts or extends.

If the directional valve 11 is in the middle position, that is in the first switch position, aeration of the working channels 24b, 24c via the feed channel 24a is blocked, however venting of the working channels 24b, 24c via the allocated ventilation ducts 24d, 24e does not take place either. This means that the pressure in the fluid consumer still in the working chambers is “locked”. However, if venting of the system, in particular the double-acting pneumatic cylinder, is to take place when no feed pressure is present, the residual pressure relief equipped with the two check valves 36a, 36b comes into operation. If residual pressure, but no feed pressure, is present in one of the two working channels 24b, 24c connected in particular to one of the two working chambers 55a, 55b, the prevailing pressure difference causes the check valve to open, that is, the check valve member 37a, 37b is moved into the open position, whereby the residual pressure can escape through the connecting channel and the relief channel. The same applies if residual pressure is applied at the other working channel 24b, 24c, then the other check valve opens and the other check valve member 37a, 37b is moved into its open position, which also allows residual pressure to escape through the connecting channel and the relief channel.

1. A directional valve comprising:
a valve housing, in which a slide receiving space is formed extending in a longitudinal direction along a longitudinal axis and limited radially outwards by a peripheral receiving space boundary surface,
in which a plurality of valve channels, which pass through the valve housing and are spaced in the longitudinal direction at points in the peripheral receiving space boundary surface, open, and
in which, a valve slide, having at least one slide body, is arranged, which is displaceable in the longitudinal direction between a plurality of switch positions under execution of a switching movement,
wherein the valve channels contain at least one feed channel that can be connected to a fluidic pressure source and at least one working channel that can be connected to an actuated fluid consumer,
wherein the feed channel opens into a feed longitudinal section and the working channel opens into a working longitudinal section of the slide receiving space axially adjoining the feed longitudinal section,
wherein the valve slide in a first switch position fluid-tightly separates the feed longitudinal section from the working longitudinal section, and in a second switch position releases a fluid connection between the feed longitudinal section and the adjacent working longitudinal section, and
at least one check valve, having a check valve member, which is movable relative to the slide body depending on the applied pressure difference,
wherein in the slide body, a receiving chamber is formed, in which the check valve member is arranged axially movable and which is connected to the feed longitudinal section via a connecting channel formed in the slide body,
wherein a valve seat is located opposite the check valve member, which borders an overflow opening, which is connected to the working longitudinal section of the slide receiving space via a relief channel.

2. The directional valve according to claim 1, wherein the valve channels contain at least one ventilation duct connectable to a pressure sink, which opens into a ventilation longitudinal section of the slide receiving space, wherein the valve slide in the first switch position fluid-tightly separates the working longitudinal section and the ventilation longitudinal section, in the second switch position fluid-tightly separates the working longitudinal section from the ventilation longitudinal section, and in a third switch position releases a fluid connection between the working longitudinal section and the ventilation longitudinal section, while simultaneously the feed longitudinal section is fluid-tightly separated from the working longitudinal section.

3. The directional valve according to claim 1, wherein a further working longitudinal section of the slide receiving space, which is connected to a further working channel, is adjoined to the side of the feed longitudinal section which axially opposes the working longitudinal section, to which a further ventilation longitudinal section of the slide receiving space, which is connected to a further ventilation duct, is axially adjoined, wherein the valve slide in the first switch position fluid-tightly separates the feed longitudinal section and the further working longitudinal section, while the further working longitudinal section is simultaneously is fluid-tightly separated from the further ventilation longitudinal section, in the second switch position the feed longitudinal section is fluid-tightly separated from the further working longitudinal section, while a fluid connection is simultaneously released between the further working longitudinal section and the further ventilation longitudinal section, and in the third switch position a fluid passage is released between the feed longitudinal section and the further working longitudinal section, and the further working longitudinal section is simultaneously fluid-tightly separated from the further ventilation longitudinal section.

4. The directional valve according to claim 3, wherein a further check valve allocated to the further working channel, having a further check valve member, which is movable relative to the slide body depending on the applied pressure difference.

5. The directional valve according to claim 4, wherein the further check valve member of the further check valve is accommodated likewise axially movable in the receiving chamber of the slide body, which is connected to the feed longitudinal section via a further connecting channel formed in the slide body, wherein a further valve seat is located opposite the further check valve member, which borders a further overflow opening, which is connected to the further working longitudinal section of the slide receiving space via a further relief channel.

6. The directional valve according to claim 1, wherein the connecting channel has a passageway channel section aligned coaxially to the longitudinal axis of the slide receiving space, which ends at the valve seat of the check valve, and wherein the connecting channel has an end channel section extending in the radial direction to the longitudinal axis, which is connected on the one hand to the passageway channel section and on the other hand to the feed longitudinal section.

7. The directional valve according to claim 5, wherein the further connecting channel has a further passageway channel section aligned coaxially to the longitudinal axis of the slide receiving space, which ends at the further valve seat of the further check valve, and wherein the further connecting channel has a further end channel section extending in the radial direction to the longitudinal axis, which is connected on the one hand to the further passageway channel section and on the other hand to the feed longitudinal section.

8. The directional valve according to claim 7, wherein the passageway channel section and the further passageway channel section are fluidically connected to each other and the end channel section and the further end channel section are one and the same channel.

9. The directional valve according to claim 1, wherein the relief channel has an overflow channel section aligned coaxially to the longitudinal axis of the slide receiving space, whose opening, which is aligned to the check valve member, forms the overflow opening, which can be closed by the check valve member, and wherein the relief channel has an inflow channel section extending in a radial direction to the longitudinal axis, which is connected on the one hand to the working longitudinal section and on the other hand to the overflow channel section.

10. The directional valve according to claim 5, the further relief channel has a further overflow channel section aligned coaxially to the longitudinal axis of the slide receiving space, whose opening, which is aligned to the further check valve member, forms the overflow opening, which can be closed by the check valve member, and wherein the further relief channel has a further inflow channel section extending in a radial direction to the longitudinal axis, which is connected on the one hand to the further working longitudinal section and on the other hand to the further overflow channel section.

11. The directional valve according to claim 1, wherein the check valve member is formed spherically or conically.

12. The directional valve according to claim 1, wherein the valve seat is formed on a valve seat body, which in turn is accommodated in the receiving chamber of the slide body and fixed there in an axially immovable manner.

13. The directional valve according to claim 1, wherein the check valve member is axially movable between a closed position, tightly fitting the valve seat and fluid-tightly closing the overflow opening, and an open position, raised from the valve seat, wherein the open position is predetermined by a stop element protruding into the receiving chamber.

14. The directional valve according claim 5, wherein the further check valve member is axially movable between a closed position, tightly fitting the further valve seat and fluid-tightly closing the further overflow opening, and an open position, raised from the further valve seat, wherein the open position is predetermined by a stop element protruding into the receiving chamber.

15. The directional valve according to claim 13, wherein the same stop element, which serves to specify the opening positions of the check valve members, has a first stop surface or the check valve member and a second stop surface, arranged opposite the first stop surface, for the further check valve member.

16. The directional valve according to claim 1, wherein the directional valve contains a spring device, by which the valve slide is held flexibly in the first switch position under preload.

17. The directional valve according to claim 1, wherein the directional valve is designed for electronic actuation of the valve slide with an electronic pilot valve device.

18. A valve slide for a directional valve, wherein the directional valve has a valve housing, in which a slide receiving space, provided for receiving the valve slide, is formed extending in a longitudinal direction along a longitudinal axis and limited radially outwards by a peripheral receiving space bordering surface, in which a plurality of valve channels, which pass through the valve housing, open, spaced in the longitudinal direction at points in the peripheral receiving space bordering surface, and wherein the valve slide has a slide body, wherein a receiving chamber is formed in the slide body, in which at least one check valve is accommodated, which has a check valve member arranged in an axially movable manner in the receiving chamber.

19. The valve slide according to claim 18, wherein the valve slide is accommodated in a directional valve comprising:
a valve housing, in which a slide receiving space is formed extending in a longitudinal direction along a longitudinal axis and limited radially outwards by a peripheral receiving space boundary surface,
a plurality of valve channels, which pass through the valve housing and are spaced in the longitudinal direction at points in the peripheral receiving space boundary surface open,
a valve slide, having at least one slide body, is arranged, which is displaceable in the longitudinal direction between a plurality of switch positions under execution of a switching movement,
wherein the valve channels contain at least one feed channel that can be connected to a fluidic pressure source and at least one working channel that can be connected to an actuated fluid consumer,
wherein the feed channel opens into a feed longitudinal section and the working channel opens into a working longitudinal section of the slide receiving space axially adjoining the feed longitudinal section,
wherein the valve slide in a first switch position fluid-tightly separates the feed longitudinal section from the working longitudinal section, and in a second switch position releases a fluid connection between the feed longitudinal section and the adjacent working longitudinal section, and
at least one check valve, having a check valve member, which is movable relative to the slide body depending on the applied pressure difference,
wherein in the slide body, a receiving chamber is formed, in which the check valve member is arranged axially movable and which is connected to the feed longitudinal section via a connecting channel formed in the slide body,
wherein a valve seat is located opposite the check valve member, which borders an overflow opening, which is connected to the working longitudinal section of the slide receiving space via a relief channel.

20. A method for retro-fitting a directional valve comprising a valve housing, in which a slide receiving space is formed extending in a longitudinal direction along a longitudinal axis and limited radially outwards by a peripheral receiving space boundary surface, a plurality of valve channels open, which pass through the valve housing and are spaced in the longitudinal direction at points in the peripheral receiving space boundary surface, and a valve slide having at least one slide body, is arranged, which is displaceable in the longitudinal direction between a plurality of switch positions by executing a switching movement, the method comprising the following steps:
removal of the valve slide from the directional valve and
replacement of the removed valve slide by installing a valve slide, in which a receiving chamber is formed, in which at least one check valve is accommodated, having a check valve member arranged in an axially movable manner in the receiving chamber.

21. The method according to claim 20, wherein the method is carried out on a directional valve comprising:
a valve housing, in which a slide receiving space is formed extending in a longitudinal direction along a longitudinal axis and limited radially outwards by a peripheral receiving space boundary surface,
a plurality of valve channels, which pass through the valve housing and are spaced in the longitudinal direction at points in the peripheral receiving space boundary surface open,
a valve slide, having at least one slide body, is arranged, which is displaceable in the longitudinal direction between a plurality of switch positions under execution of a switching movement,
wherein the valve channels contain at least one feed channel that can be connected to a fluidic pressure source and at least one working channel that can be connected to an actuated fluid consumer,
wherein the feed channel opens into a feed longitudinal section and the working channel opens into a working longitudinal section of the slide receiving space axially adjoining the feed longitudinal section,
wherein the valve slide in a first switch position fluid-tightly separates the feed longitudinal section from the working longitudinal section, and in a second switch position releases a fluid connection between the feed longitudinal section and the adjacent working longitudinal section, and
at least one check valve, having a check valve member, which is movable relative to the slide body depending on the applied pressure difference,
wherein in the slide body, a receiving chamber is formed, in which the check valve member is arranged axially movable and which is connected to the feed longitudinal section via a connecting channel formed in the slide body,
wherein a valve seat is located opposite the check valve member, which borders an overflow opening, which is connected to the working longitudinal section of the slide receiving space via a relief channel.
